(19) United States
(12) Patent Application Publication
(10) Pub. No.: US 2014/0009919 A1
(43) Pub. Date: Jan. 9, 2014

(54) ILLUMINATING MOUSE

(71) Applicants: FIH (Hong Kong) Limited, Kowloon (HK); Shenzhen Futaihong Precision Industry Co., Ltd., Shenzhen (CN)

(72) Inventor: JIAN-HUI LI, Shenzhen (CN)

(21) Appl. No.: 13/924,704

(22) Filed: Jun. 24, 2013

(30) Foreign Application Priority Data
Jul. 9, 2012 (CN) 2012102353206

(51) Int. Cl. F21V 33/00

(52) U.S. Cl. CPC F21V 33/0048
USPC 362/184; 362/234

(57) ABSTRACT

An illuminating mouse includes a mouse body defining a receiving groove and a light source assembly received in the receiving groove. A series of links are constituted by a number of connecting arm assemblies and rods, and upon full extension of all the links, a covered light source attached to the topmost connecting arm assembly is elevated above, and provides illumination for, a work surface. In a first configuration, the cover, the connecting arm assemblies and the rods are all received in the receiving groove and the normal mouse function is available. In a second configuration, the light source assembly is pulled out of the receiving groove and the illuminating mouse also functions as a lamp.

### BACKGROUND

1. Technical field

The disclosure generally relates to mice, and particularly to an illuminating mouse.

2. Description of the Related Art

When people uses computers in the dark, even if a luminous display screen of the computer can illuminate a keyboard, the light from the display screen is not bright enough for any other activity. Furthermore, using computers in the dark is bad for users' eyes.

Therefore, there is room for improvement within the art.

### BRIEF DESCRIPTION OF THE DRAWINGS

Many aspects of an exemplary illuminating mouse can be better understood with reference to the following drawings. The components in the drawings are not necessarily drawn to scale, the emphasis instead being placed upon clearly illustrating the principles of the exemplary illuminating mouse. Moreover, in the drawings, like reference numerals designate corresponding parts throughout the several views. Wherever possible, the same reference numbers are used throughout the drawings to refer to the same or like elements of an embodiment.

FIG. 1 is a schematic view of an illuminating mouse in a first state of use, according to an exemplary embodiment.

FIG. 2 is similar to FIG. 1, but shown in another state of use.

FIG. 3 is an exploded view of the illuminating mouse shown in FIG. 1.

FIG. 4 is a block diagram of the illuminating mouse shown in FIG. 1.

FIG. 5 is a schematic view of a switch module shown in FIG. 4.

### DETAILED DESCRIPTION

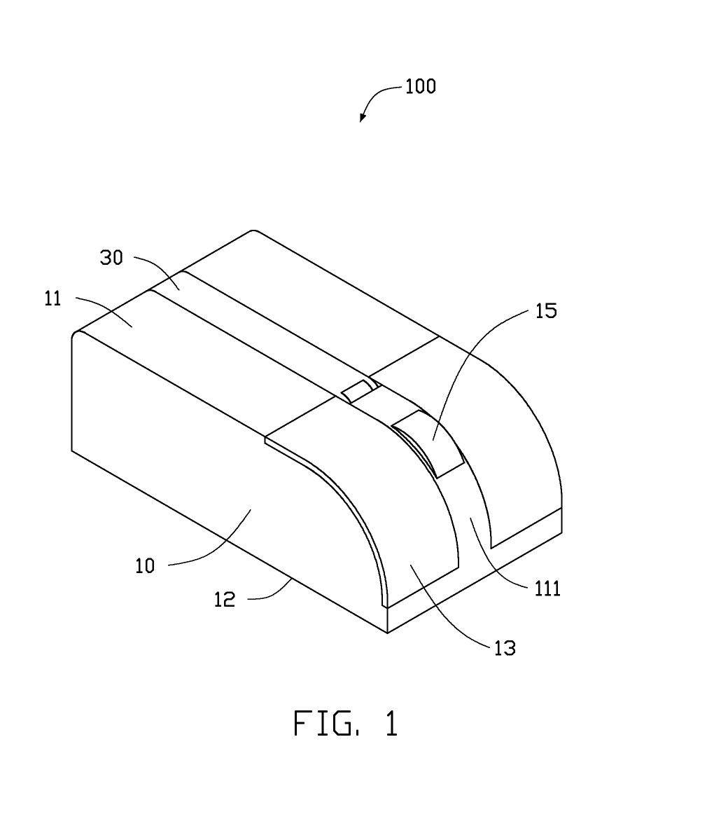

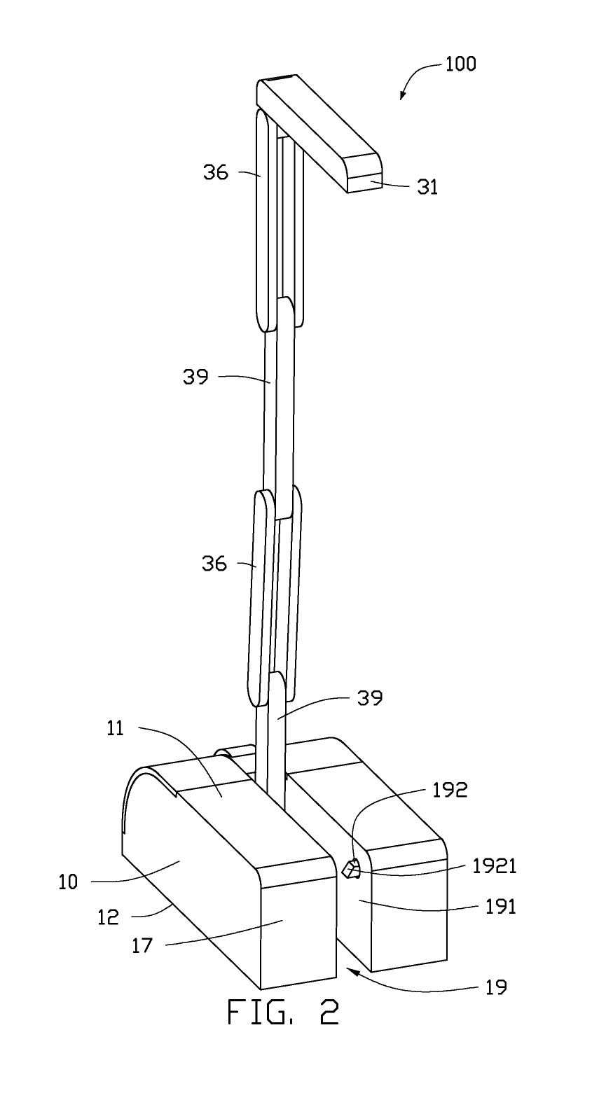

FIG. 1 and FIG. 2 show an illuminating mouse 100 of an exemplary embodiment. The illuminating mouse 100 includes a mouse body 10 and a light source assembly 30 assembled in the mouse body 10.

The mouse body 10 includes a first surface 11, a second surface 12 connected to the first surface 11 and an end surface 17. The end surface 17 connects the first surface 11 to the second surface 12. The first surface 11 includes an arcuate portion 111 spaced from the end surface 17. The arcuate portion 111 is connected to the second surface 12. Two buttons 13 and a scrolling wheel 15 between the two buttons 13 are located on the arcuate portion 111. The end surface 17 defines a receiving groove 19. The receiving groove 19 extends toward the buttons 13 and runs through part of the first surface 11 and part of the second surface 12. The light source assembly 30 is received in the receiving groove 19.

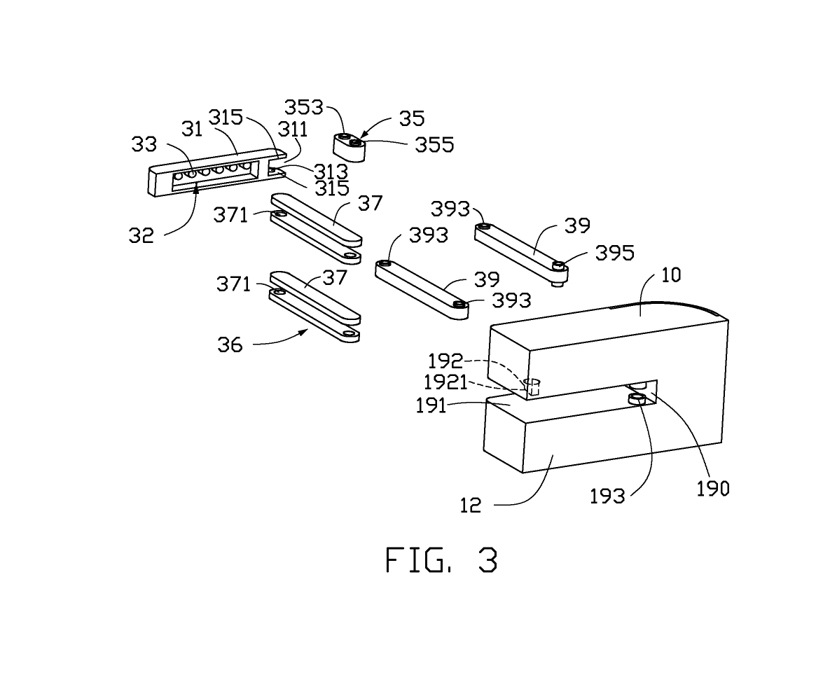

Also referring to FIG. 3, the receiving groove 19 is defined by an end wall 190 and two opposite sidewalls 191. A clasp portion 193 is located on each sidewall 191, and is adjacent to the end wall 190. A switch 192 is located on one of the two sidewalls 191. The switch 192 is spaced from the end wall 190 and includes a slope 1921.

The light source assembly 30 includes a cover 31, a plurality of light sources 33, a rotating element 35, at least one connecting arm assembly 36 and at least one rod 39. The cover 31 defines a groove 32 for receiving the plurality of light sources 33. In the embodiment, the plurality of light sources 33 are a plurality of light emitting diodes (LEDs). An end of the cover 31 defines a recess 311. The recess 311 includes two opposite extending plates 315. Each extending plate 315 defines a hole 313. The rotating element 35 is substantially an elliptical body. A first pivot portion 353 and a second pivot portion 353 pass through the rotating element 35, and two opposite ends of the first pivot portion 353 and two opposite ends of the second pivot portion 353 are exposed out of the rotating element 35. The two opposite ends of the first pivot portion 353 are rotatably received in the holes 313 for rotatably connecting the rotating element 35 and the cover 31.

In the embodiment, there are two connecting arm assemblies 36 and two rods 39. Each connecting arm assembly 36 is made of two parallel connecting arms 37. An inner surface of each connecting arm 37 defines two opposite engaging grooves 371. The two engaging grooves 371 of one of the connecting arms 37 are opposite to the two engaging grooves 371 of the other one of the connecting arms 37. Each rod 39 has a shaft 393 located at each of its ends. Two opposite ends of each shaft 393 can be rotatably received in the engaging grooves 371 located at one end of the connecting arm assembly 36. In the embodiment, one of the two rods 39 includes a shaft 395 having a greater length than the other shaft 393. The greater-length shaft 395 is rotatably engaged with the clasp portions 193.

FIGS. 2 and 3 show the assembly process of the illuminating mouse 100:

Two ends of the first pivot portion 353 are rotatably received in the holes 313. Two ends of the second pivot portion 355 are rotatably received in two engaging grooves 371 located at one end of the connecting arm assembly 36. Thus, the cover 31 is rotatably connected to the parallel connecting arms 37 of one connecting arm assembly 36. Then, the two engaging grooves 371 located at a free end of the connecting arm assembly 36 are rotatably engaged with the shaft 393 of one rod 39. The shaft 393 located at a free end of the rod 39 is rotatably engaged with two engaging grooves 371 located at one end of the other connecting arm assembly 36. Two engaging grooves 371 located at a free end of the other connecting arm assembly 36 are rotatably engaged with a shaft 393 of the other rod 39. The greater-length shaft 395 is rotatably engaged with the clasp portions 193.

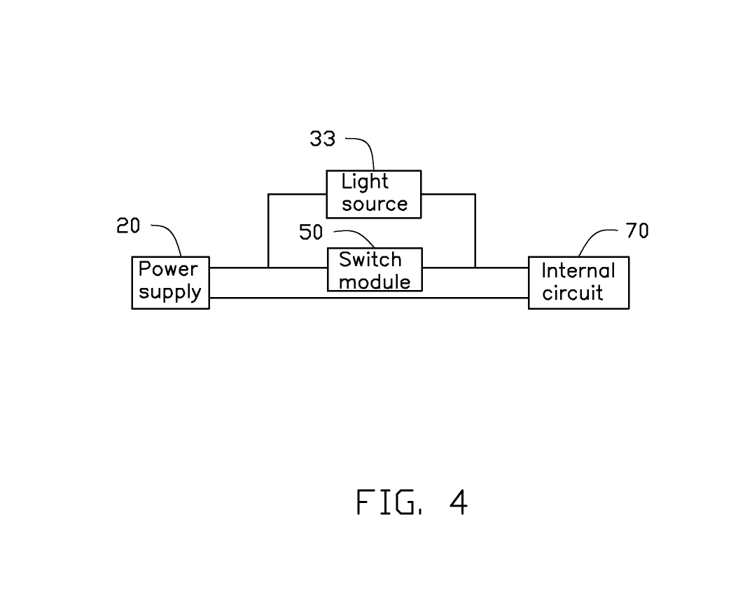

FIG. 4 shows a block diagram of the illuminating mouse 100. The illuminating mouse 100 includes a power supply 20, a switch module 50 and an internal circuit 70. The power supply 20, the switch module 50 and the internal circuit 70 constitute a first circuit loop. The plurality of light sources 33 and the switch module 50 are in parallel, and the power supply 20, the plurality of light sources 33 and the internal circuit 70 constitute a second circuit loop. In the embodiment, the internal circuit 70 is a conventional circuit of a conventional mouse.

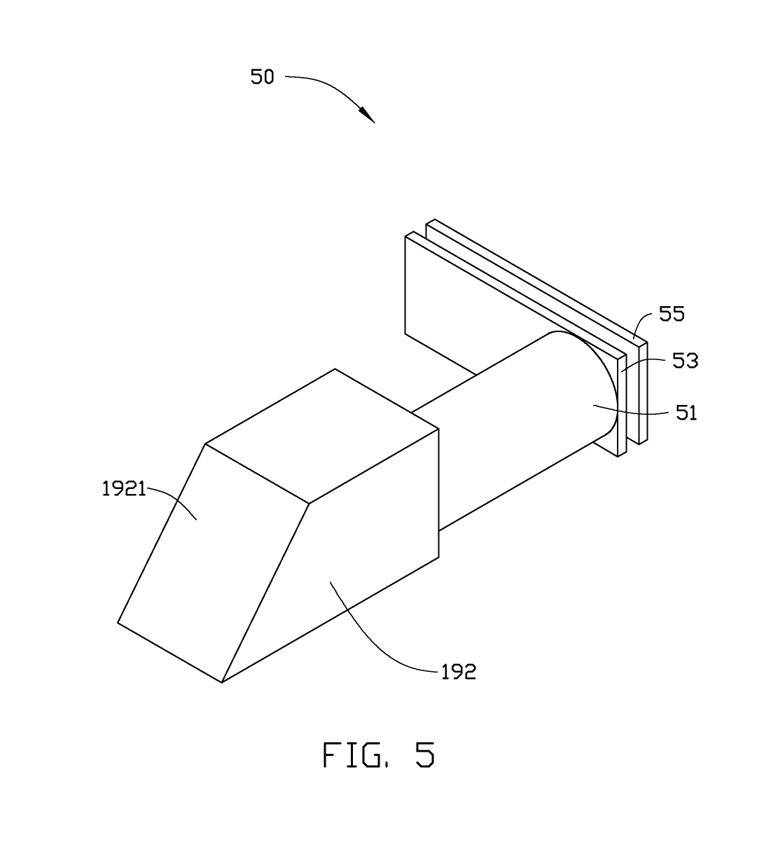

Also referring to FIG. 5, the switch module 50 includes the switch 192, an elastic element 51, a first conducting strip 53 and a second conducting strip 55. In the embodiment, the elastic element 51 is a spring. The switch 192 is connected to a first end of the elastic element 51. A second end of the elastic element 51 is connected to the first conducting strip 53. The first conducting strip 53 and the second conducting strip 55 are parallel and are spaced from each other. The first conducting strip 53 is electronically connected to the power supply 20, and the second conducting strip 55 is electronically connected to the internal circuit 70.

When the light source assembly 30 is received in the receiving groove 19 of the mouse body 10, the cover 31 bears against the slope 1921 of the switch 192. The first conducting strip 53 bears against the second conducting strip 55 under an elastic force of the elastic element 51, and the switch module 50 is thus closed. Accordingly, the first circuit loop is closed. Current from the power supply 20 does not flow to the plurality of light sources 33, and the plurality of light sources 33 are not lit. If the light source assembly 30 is pulled out of the mouse body 10, the switch 192 returns to its original position under an elastic restoring force of the elastic element 51. The first conducting strip 53 separates from the second conducting strip 55, and the switch module 50 is opened. Thus, the first circuit loop is opened, and the second circuit loop is closed. The plurality of light sources 33 thus emit light and the illuminating mouse 100 functions as a table lamp.

The illuminating mouse 100 includes a mouse body 10 and a light source assembly 30 assembled in the mouse body 10, and the illuminating mouse 100 can be used for lighting. The light source assembly 30 can be pulled out of the mouse body 10 and can be folded back into the mouse body 10, the illuminating mouse 100 is convenient to use.

The connecting arm 37 and the rod 39 can be hollow to allow for wiring.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of exemplary disclosure to the full extent indicated by the broad general meaning of the terms in which the appended claims are expressed.

What is claimed is:

1. An illuminating mouse, comprising:
a mouse body defining a receiving groove; and
a light source assembly received in the receiving groove, the light source assembly comprising a cover, a plurality of light sources received in the cover, a connecting arm assembly and a rod, the connecting arm assembly is rotatably connected to the cover, and the rod; the rod is rotatably connected to the mouse body;
wherein in a first configuration, the cover ,the connecting arm assembly and the rod are received in the receiving groove; and
in a second configuration, the light source assembly is pulled out of the receiving groove and the illuminating mouse functions as a lamp.

2. The illuminating mouse as claimed in claim 1, wherein the light source assembly further comprises a rotating element, the cover is rotatably connected to the connecting arm assembly by the rotating element.

3. The illuminating mouse as claimed in claim 2, wherein the connecting arm assembly is made of two parallel connecting arms, an inner wall of each connecting arm defines two opposite engaging grooves; the two engaging grooves of one connecting arm are opposite to the two engaging grooves of the other connecting arm.

4. The illuminating mouse as claimed in claim 3, wherein a shaft is located at each end of the rod; two ends of one shaft are rotatably received in the engaging grooves, and two ends of the other shaft are rotatably connected to the mouse body and received in the receiving groove.

5. The illuminating mouse as claimed in claim 1, wherein the receiving groove comprises an end wall and two opposite sidewalls, the end wall connects to the two opposite sidewalls.

6. The illuminating mouse as claimed in claim 5, further comprises a power supply, a switch module and an internal circuit; the power supply, the switch module and the internal circuit constitute a first circuit loop; the plurality of light sources and the switch module are in parallel, and the power supply, the plurality of light sources and the internal circuit constitute a second circuit loop.

7. The illuminating mouse as claimed in claim 6, wherein the switch module comprises a switch, an elastic element, a first conducting strip and a second conducting strip; the switch is located on one of the two sidewalls and is connected to a first end of the elastic element, a second end of the elastic element is connected to the first conducting strip; the first conducting strip and the second conducting strip are parallel and are spaced from each other.

8. The illuminating mouse as claimed in claim 7, wherein the first conducting strip is electronically connected to the power supply, and the second conducting strip is electronically connected to the internal circuit.

9. The illuminating mouse as claimed in claim 8, wherein when the light source assembly is received in the receiving groove, the cover bears against the switch; the first conducting strip bears against the second conducting strip under an elastic force of the elastic element, and then the first circuit loop is closed.

10. The illuminating mouse as claimed in claim 8, wherein when the light source assembly is pulled out of the mouse body, the switch returns to its original position under an elastic restoring force of the elastic element; the first conducting strip separates from the second conducting strip, the first circuit loop is opened, the second circuit loop is closed, and the plurality of light sources emit light.

11. An illuminating mouse, comprising:
a mouse body defining a receiving groove; and
a light source assembly received in the receiving groove, the light source assembly comprising a plurality of light sources;
wherein the illuminating mouse further comprises a power supply, a switch module and an internal circuit; the power supply, the switch module and the internal circuit constitute a first circuit loop; the plurality of light sources and the switch module are in parallel, and the power supply, the plurality of light sources and the internal circuit constitute a second circuit loop; when the switch module is closed, the first circuit loop is closed; when the switch module is opened, the second circuit loop is opened.

12. The illuminating mouse as claimed in claim 11, wherein the receiving groove comprises a sidewall; a switch is located on the sidewall; when the light source assembly bears against the switch, the switch module is closed.

13. The illuminating mouse as claimed in claim 12, wherein the switch module comprises the switch, an elastic element, a first conducting strip and a second conducting strip; the switch is connected to a first end of the elastic element, a second end of the elastic element is connected to the first conducting strip; the first conducting strip and the second conducting strip are parallel and are spaced from each other.

14. The illuminating mouse as claimed in claim 13, wherein the first conducting strip is electronically connected to the power supply, and the second conducting strip is electronically connected to the internal circuit.

15. The illuminating mouse as claimed in claim 14, wherein when the light source assembly is received in the receiving groove to resist the switch, the first conducting strip bears against the second conducting strip under an elastic force of the elastic element, and then the first circuit loop is closed.

16. The illuminating mouse as claimed in claim 14, wherein when the light source assembly is pulled out of the mouse body, the switch returns to its original position under an elastic restoring force of the elastic element; the first conducting strip separates from the second conducting strip, the first circuit loop is opened, the second circuit loop is closed, and the plurality of light sources emit light.

17. The illuminating mouse as claimed in claim 11, wherein the light source assembly further comprises a cover, a connecting arm assembly and a rod, the plurality of light sources is received in the cover; the connecting arm assembly is rotatably connected to the cover, and the rod; the rod is rotatably connected to the mouse body.

18. The illuminating mouse as claimed in claim 17, wherein the light source assembly further comprises a rotating element, the cover is rotatably connected to the connecting arm assembly by the rotating element.

19. The illuminating mouse as claimed in claim 17, wherein the connecting arm assembly is made of two parallel connecting arms, an inner wall of each connecting arm defines two opposite engaging grooves; the two engaging grooves of one connecting arm are opposite to the two engaging grooves of the other connecting arm.

20. The illuminating mouse as claimed in claim 19, wherein a shaft is located at each end of the rod; two ends of one shaft are rotatably received in the engaging grooves, and two ends of the other shaft are rotatably connected to the mouse body and received in the receiving groove.
